(19) United States
(12) Patent Application Publication
(10) Pub. No.: US 2023/0081278 A1
(43) Pub. Date: Mar. 16, 2023

(54) CONNECTOR SUBASSEMBLY AND ELECTRONIC DEVICE USING THE SAME

(71) Applicant: HONG FU JIN PRECISION INDUSTRY (WuHan) CO., LTD., Wuhan (CN)

(72) Inventor: FENG ZHANG, Wuhan (CN)

(21) Appl. No.: 17/670,026

(22) Filed: Feb. 11, 2022

Related U.S. Application Data
(63) Continuation-in-part of application No. PCT/CN2021/117793, filed on Sep. 10, 2021.

(51) Int. Cl. H01R 24/60; H01R 13/03

(52) U.S. Cl. CPC H01R 24/60; H01R 13/03

(57) ABSTRACT

The disclosure provides a connector and an electronic device using the connector. The connector subassembly includes two connectors that plug into each other, the connector includes a terminal support component, the terminal support component includes a first surface and a second surface, the first surface is opposite to the second surface or the first surface and the second surface are arranged at intervals; a multiple of gold fingers are symmetrically arranged on the first surface and the second surface; an electric conversion component includes a main electric unit and two auxiliary conductive units, the main electric unit is electrically connected the two auxiliary conductive units and a conductive element; the two auxiliary conductive units are electrically connected with the gold fingers. The gold fingers are respectively arranged on the first surface and the second surface of the terminal support component.

### FIELD

The subject matter relates to a connector subassembly and an electronic device using the same.

### BACKGROUND

Current mainstream electronic products, such as mobile phones, computers, smart home appliances and other electronic products are equipped with connectors. The connector can be used for transmitting electrical signals, charging and discharging, etc. In order to improve user experience, double-sided pluggable connectors are becoming a necessary structure in mainstream electronic products.

Existing double-sided pluggable connectors tend to experience significant signal attenuation when applied to high frequency signals (frequencies greater than 1 GHz). How to solve the above problems is the technical personnel in this field need to consider.

### SUMMARY

The purpose of the invention is to solve the problem of signal attenuation faced by the double-sided pluggable connector applied to high frequency signals in the prior art.

A connector subassembly comprising two connectors that plug into each other, the connector comprising:
a terminal support component, wherein the terminal support component comprises a first surface and a second surface, the first surface is opposite to the second surface or the first surface and the second surface are arranged at intervals;
a multiple of gold fingers symmetrically arranged on the first surface and the second surface; and
an electric conversion component comprising a main electric unit and two auxiliary conductive units, wherein the main electric unit is electrically connected the two auxiliary conductive units and a conductive element; the two auxiliary conductive units are electrically connected with the gold fingers that respectively arranged on the first surface and the second surface of the terminal support component.

Furthermore, the joint connected the two auxiliary conductive units and the main electrical unit is located inside the connector.

Furthermore, the joint further connects the two auxiliary conductive units with the main electrical unit, and the two auxiliary conductive units are non-contacting and insulated from each other in areas other than the joint.

Furthermore, the multiple of gold fingers are positioned at a first end of the terminal support component, the gold fingers comprise a first terminal group and a second terminal group arranged at intervals, the first terminal group and the second terminal group has the same number of the gold fingers, the first terminal group is arranged on the first surface, and the second terminal group is arranged on the second surface.

Furthermore, the electric conversion component is arranged on a second end of the terminal support component opposite to the first end, and the main electrical unit is arranged on a side of the auxiliary conductive unit away from the multiple of gold fingers.

Furthermore, the terminal support component is plate shaped whose two major surfaces define the first and the second surfaces.

Furthermore, the connector is further configured to receive a mother board, and the connector further comprises a shell, the shell wraps with the terminal support component, and the first end of the terminal support component is extended toward the opening of the shell.

Furthermore, the terminal support component is hollow column shaped whose two major surfaces define the first and the second surfaces, the first surface and the second surface are arranged face to face, and the first end of the terminal support component is extended toward the opening of the hollow column terminal support component.

Furthermore, the connector is further configured to receive a cable.

An electronic device comprises a function subassembly and a connector subassembly, the connector subassembly is electrically connected with the functional subassembly to transmit electrical signals, the connector subassembly comprising two connectors that plug into each other.

Compared to prior art, the electric conversion component comprises a main electric unit and two auxiliary conductive units, the main electric unit and the two auxiliary conductive units are electrically connected; the main electric unit is electrically connected with the conductive element; the two auxiliary conductive units are electrically connected with gold fingers that respectively arranged on two sides of the phase back of the terminal support component. The two auxiliary conductive units are bifurcated by the main electrical unit. The two auxiliary conductive units are respectively connected to two groups of the gold fingers set at intervals, so as to realize the double-sided plug and pull function of the connector. The two connectors with the above structure cooperate with each other, so that the electrical signals can be transmitted through the symmetrical setting of the gold finger, avoiding the loss caused by the transmission of electrical signals in short circuit or open circuit, and effectively reducing the attenuation of high-frequency electrical signals in the transmission process.

### BRIEF DESCRIPTION OF THE DRAWINGS

FIG. 1 is a structure view of a connector subassembly according to an embodiment of the present disclosure.

FIG. 2 is a structure view of a connector of the connector subassembly of FIG. 1.

FIG. 3 is a cross-sectional view along a view line III-III of FIG. 2.

FIG. 4 is a structure view of the connector of FIG. 2.

FIG. 5 is a structure view of another connector of the connector subassembly of FIG. 1.

FIG. 6 is a cross-sectional view along a view line VI-VI of FIG. 5.

FIG. 7 is a structure view of the connector of FIG. 5.

FIG. 8 is schematic view of electronic simulation test of the connector subassembly according to FIG. 1.

FIG. 9 is a structure view of an electronic device according to an embodiment of the present disclosure.

### DETAILED DESCRIPTION

The following descriptions refer to the attached drawings for a more comprehensive description of this application. Sample embodiments of this application are shown in the attached drawings. However, this application can be implemented in many different forms and should not be construed as limited to exemplary embodiments set forth herein. These exemplary embodiments are provided to make this application thorough and complete, and to adequately communicate the scope of this application to those skilled in the field. Similar diagram tags represent the same or similar components.

The terms used herein are intended only to describe the purpose of particular exemplary embodiments and are not intended to limit this application. As used herein, the singular forms “one”, “one” and “the” are intended to include the plural as well, unless the context otherwise clearly indicates it. In addition, when used herein, the words “include” and/or “include” and/or “have”, integers, steps, operations, components and/or components, without excluding the existence or addition of one or more other features, regions, integers, steps, operations, components, components and/or groups thereof.

Unless otherwise defined, all terms used herein (including technical and scientific terms) have the same meaning as would normally be understood by ordinary technicians in the field of this application. In addition, unless expressly defined in the context, terms such as those defined in a general dictionary shall be construed to have meanings consistent with those in the relevant technology and in the content of this application, and shall not be construed to have idealistic or overly formal meanings.

Examples of embodiments are described below in combination with the attached drawings. It should be noted that the components depicted in the attached drawings may not be shown to scale; The same or similar components will be assigned the same or similar drawing mark representation or similar technical terms.

The following is a detailed description of the specific implementation of this application by referring to the attached drawings.

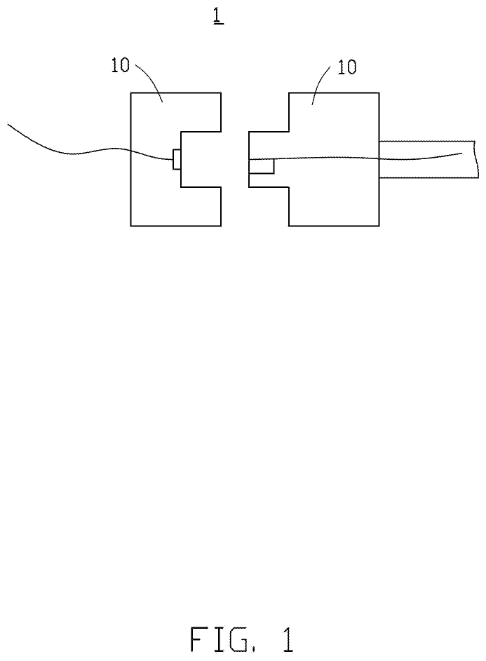

FIG. 1 shows a connector subassembly 1 of this application for an embodiment. The connector subassembly 1 includes two interchangeable connectors 10. Among the two interconnecting connectors 10 of the connector subassembly 1, the terminal support component 13 of one connector 10 includes the first surface 131 and the second surface 132 at intervals, and the terminal support component 13 of the other connector 10 includes the first surface 131 and the second surface 132 of the phase back.

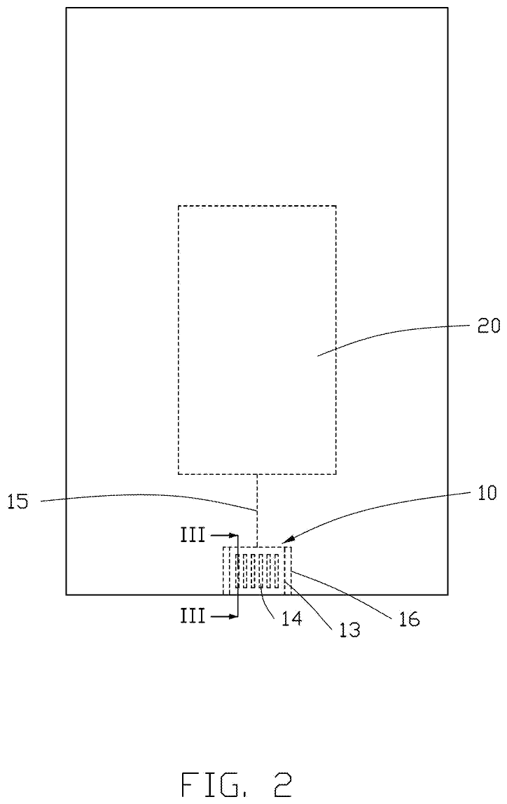

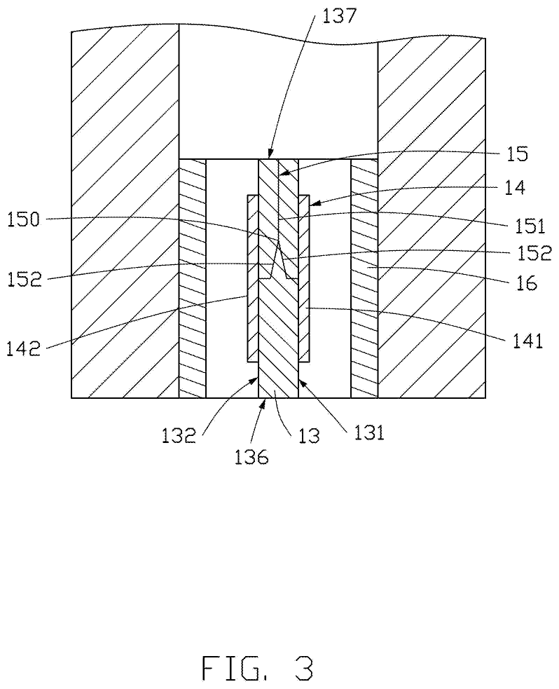

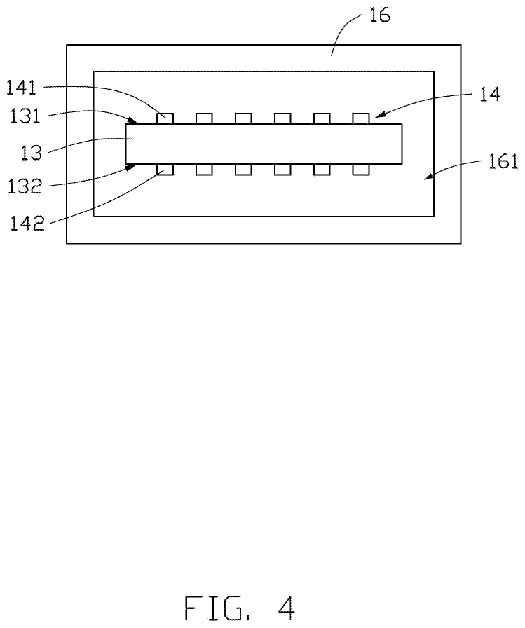

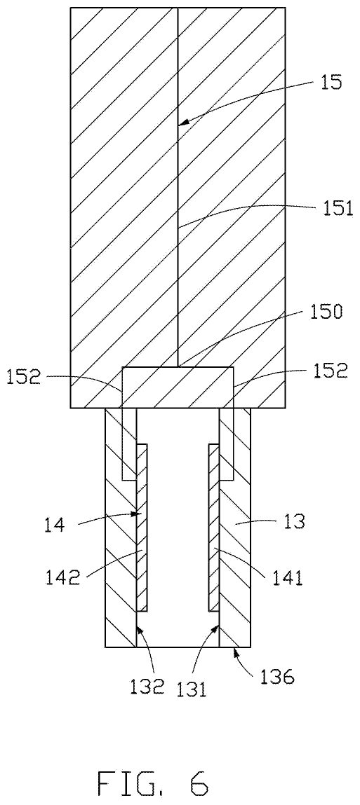

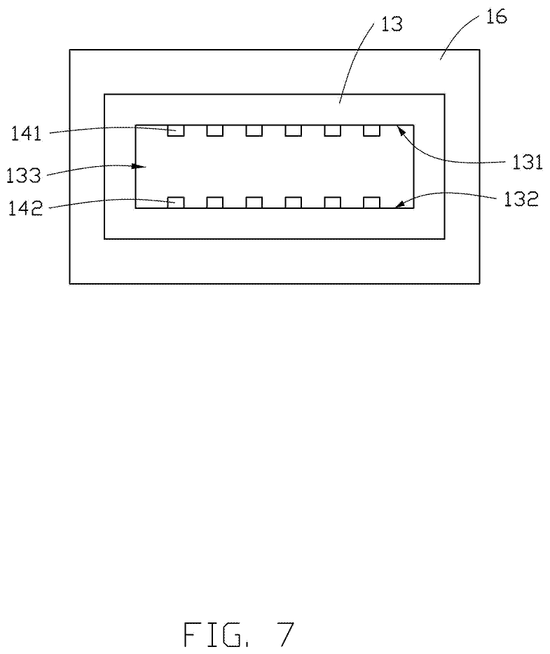

As shown in FIG. 2 to FIG. 7, connector 10 is connected to a conductive element 20 outside connector assembly 1 to transmit an electrical signal. The external conducting element 20 may connect to another connector 10.

The connector 10 comprises terminal support component 13, gold finger 14, electric conversion component 15.

Wherein, the gold finger 14 is arranged on the terminal support component 13, the electric conversion component 15 is electrically connected to the gold finger 14. The gold finger 14 is electrically connected to the external conductive element 20 through the electric conversion component 15.

Furthermore, the terminal support component 13 comprises a first surface 131 and a second surface 132, the first surface 131 is opposite to the second surface 132 or the first surface 131 and the second surface 132 are arranged at intervals. A multiple of gold fingers 14 symmetrically arranged on the first surface 131 and the second surface 132. The electric conversion component 15 comprises a main electric unit 151 and two auxiliary conductive units 152. The main electric unit 151 is electrically connected the two auxiliary conductive units 152 and the conductive element 20. The two auxiliary conductive units 152 are electrically connected with gold fingers 14 that respectively arranged on the first surface 131 and the second surface 132 of the terminal support component 13.

Furthermore, the two auxiliary conductive units 152 intersect with the main electrical unit 151 at the same joint 150. The two auxiliary conductive units 152 are non-contacting and insulated with each other in areas other than the joint 150. And, it can be understand, the two auxiliary conductive units 152 are electrically connected to the main electrical unit 151, or the two auxiliary conductive units 152 are extended from the main electrical unit 151. The two auxiliary conductive units 152 are bifurcated within connector 10, and the two auxiliary conductive units 152 are respectively connected to multiple of distant gold fingers 14.

The two connectors 10 cooperate with each other, so that the electrical signals can be transmitted through the symmetrical setting of golden finger 14, avoiding the loss caused by the transmission of electrical signals in short circuit or open circuit, and effectively reducing the attenuation of high-frequency electrical signals in the transmission process.

In one embodiment, two connectors 10 of connector subassembly 1 are provided with joint 150. After the interconnection of connector subassembly 1, all gold fingers 14 are connected (short circuit without connection), so that the attenuation loss of electrical signal in the transmission process is low. It can be understood that the joint 150 of the two connectors 10 is not limited to being inside connector 10 and can therefore extend outside of connector 10 while remaining electrically connected to gold finger 14. In other embodiments, the joint 150 of the two auxiliary conductive units 152 and the dominant electrical unit 151 may be located inside the electrical connector assembly 10, and the joint 150 of the two connectors 10 may both be located inside the connector 10.

Furthermore, the gold fingers 14 are positioned at a first end 136 of the terminal support component 13. The gold fingers 14 comprise a first terminal group 141 and a second terminal group 142 at intervals. The first terminal group 141 and the second terminal group 142 has the same number of the gold fingers 14. The first terminal group 141 can be arranged on the first surface 131, and the second terminal group 142 can be arranged on the second surface 132. In this embodiment, gold fingers 14 are equally divided into the first terminal group 141 and the second terminal group 142 in the same number. The first terminal group 141 and the second terminal group 142 are set symmetrically. The first terminal group 141 and the second terminal group 142 are symmetrically arranged at the first end 136 of the terminal support component 13. The first terminal group 141 and the second terminal group 142 are used for electrical connection with other conductive elements for transmission of electrical signals.

Furthermore, the electric conversion component 15 is arranged on a second end 137 of the terminal support component 13 opposite to the first end 136. The main electrical unit 151 is arranged on a side of the auxiliary conductive unit 152 away from the gold finger 14. That is, the main electrical unit 151 is electrically connected with the external conductive element 20 to realize the transmission of electrical signals. The main electrical unit 151 “bifurcates” the signal at the joint 150, and electrically connects the “bifurcated” signal with the first terminal group 141 and the second terminal group 142 through the two auxiliary conductive units 152 to realize the transmission of electrical signals.

As shown in FIG. 2 to FIG. 4, is a structure view of the connector 10 according to the embodiment. The connector 10 can be used in an electronic device.

The conductive element 20 is a mother board of a circuit board, the mother board of the circuit board can be a main board of the electronic device or a connection board that is connected to the main board of the electronic device. The electronic device is electrically connected with other transmission units through the connector 10.

The connector 10 further comprises a shell 16. The shell 16 can be an accommodate structure to accommodate with terminal support component 13, gold finger 14 and electrical adapter component 15. The shell 16 comprises at least one first opening 161. The shell 16 wraps with the terminal support component 13. The first end 136 of the terminal support component 13 is extended toward the first opening 161 of the shell 16.

Wherein, the first surface 131 and the second surface 132 are arranged opposite each other. The first surface 13 land the second surface 132 are respectively arranged on two sides of the terminal support component 13.

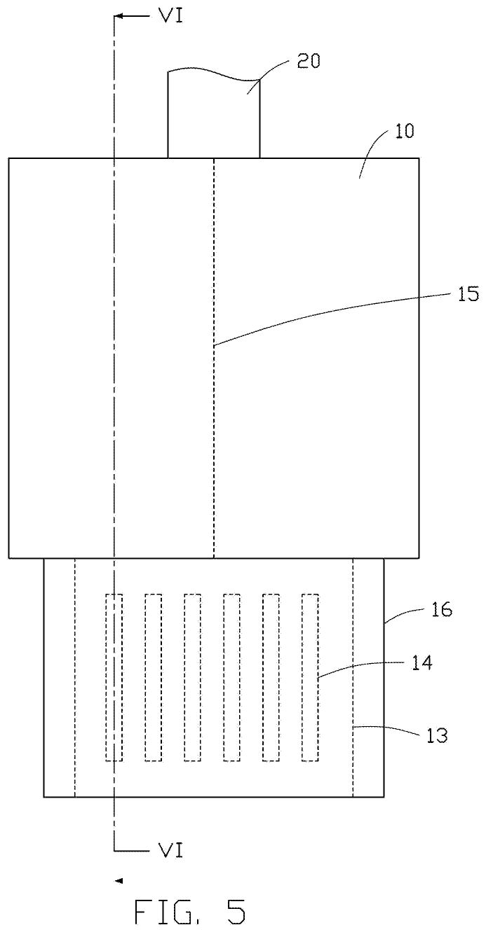

As shown in FIG. 5 to FIG. 7, is a structure view of the connector 10 according to another embodiment. The connector 10 can be arranged at the end of a cable used to connect an electronic device. In this embodiment, conductive element 20 is the cable.

The first surface 131 and the second surface 132 are arranged face to face, the first surface 131 and the second surface 132 are arranged on the opposite sides of the inner surface of the hollow column terminal support component 13. The first end 136 of the terminal support component 13 is oriented toward the second opening 133 of the hollow column terminal support component 13.

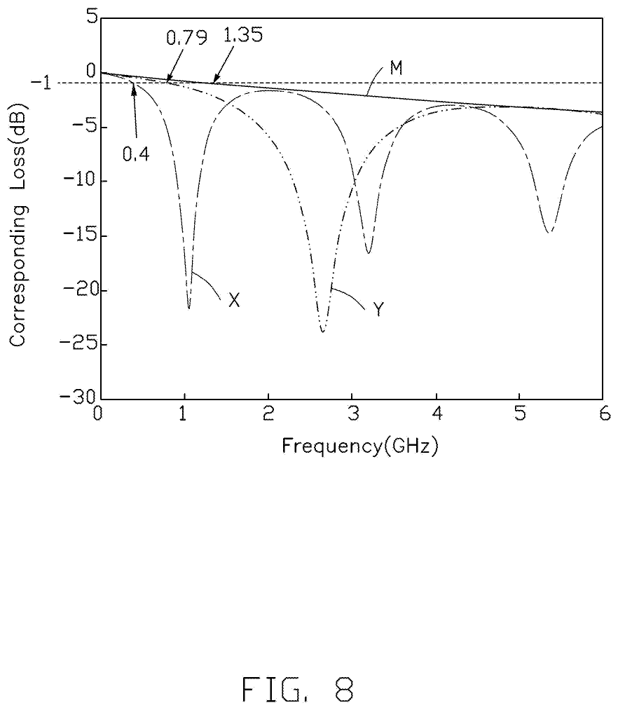

FIG. 8 shows the structure view of an electronic device 10, with 1 dB bandwidth as cut-off frequency. Among them, curves X and Y represent the change curve of electrical signal attenuation when the connector 150 is not set for “bifurcating” in the traditional technology. The cut-off frequency of curve X is 0.4 ghz, and that of curve Y is 0.79 ghz. Curve M represents the change curve of electrical signal attenuation of the electronic device with a pair of joint 150 adopted in this application embodiment. The cutoff frequency of curve M is 1.35 ghz, and the corresponding loss of curve M is lower, with larger bandwidth and better performance. According to the curve M in the figure, connector 10 applied in this paper can effectively reduce the loss of high-frequency electrical signals in the transmission process.

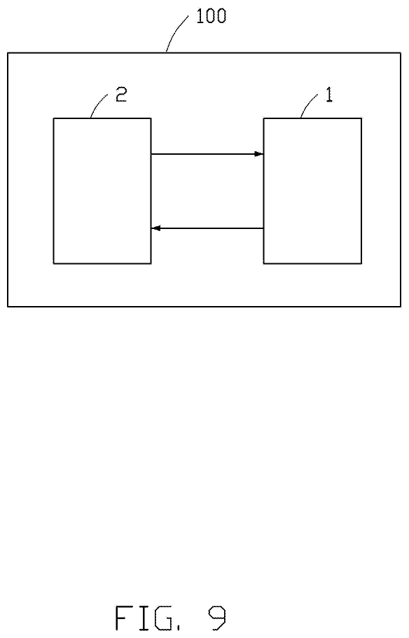

As shown in FIG. 9, this application embodiment also provides an electronic device 100. The electronic device 100 comprises a functional subassembly 2 and a connector 10 electrically connected with the functional subassembly 2 to realize electrical signal interaction. In this embodiment, the electronic device 100 in FIG. 9 can be a personal computer, an intelligent home appliance, an industrial controller, an electric vehicle, a petrol-electric hybrid vehicle, etc.

The embodiments shown and described above are only examples. Therefore, many commonly-known features and details are neither shown nor described. Even though numerous characteristics and advantages of the present technology have been set forth in the foregoing description, together with details of the structure and function of the present disclosure, the disclosure is illustrative only, and changes may be made in the detail, including in matters of shape, size, and arrangement of the parts within the principles of the present disclosure, up to and including the full extent established by the broad general meaning of the terms used in the claims. It will therefore be appreciated that the embodiments described above may be modified within the scope of the claims.

What is claimed is:

1. A connector subassembly comprising:
two connectors which are configured to be plugged into each other, each of the two connectors comprising:
a terminal support component, wherein the terminal support component comprises a first surface and a second surface, the first surface of one of the two connectors is opposite to the second surface, and the first surface and the second surface of the other connector are arranged at intervals;
a multiple of gold fingers symmetrically arranged on the first surface and the second surface; and
an electric conversion component comprising a main electric unit and two auxiliary conductive units, wherein the main electric unit is electrically connected the two auxiliary conductive units and a conductive element; the two auxiliary conductive units are electrically connected with the gold fingers, the multiple of gold fingers are respectively arranged on the first surface and the second surface of the terminal support component.

2. The connector subassembly of claim 1, wherein the joint connected the two auxiliary conductive units and the main electrical unit is located inside the connector.

3. The connector subassembly of claim 2, wherein the joint further connects the two auxiliary conductive units with the main electrical unit, and the two auxiliary conductive units are non-contacting and insulated from each other in areas other than the joint.

4. The connector subassembly of claim 3, wherein the multiple of gold fingers are positioned at a first end of the terminal support component, the gold fingers comprise a first terminal group and a second terminal group arranged at intervals, the first terminal group and the second terminal group has the same number of the gold fingers, the first terminal group is arranged on the first surface, and the second terminal group is arranged on the second surface.

5. The connector subassembly of claim 4, wherein the electric conversion component is arranged on a second end of the terminal support component opposite to the first end, and the main electrical unit is arranged on a side of the auxiliary conductive unit away from the multiple of gold fingers.

6. The connector subassembly of claim 5, wherein the terminal support component is plate shaped whose two major surfaces define the first and the second surfaces.

7. The connector subassembly of claim 6, wherein the connector is further configured to receive a mother board, and the connector further comprises a shell, the shell wraps with the terminal support component, and the first end of the terminal support component is extended toward the opening of the shell.

8. The connector subassembly of claim 5, wherein the terminal support component is hollow column shaped whose two major surfaces define the first and the second surfaces, the first surface and the second surface are arranged face to face, and the first end of the terminal support component is extended toward the opening of the hollow column terminal support component.

9. The connector subassembly of claim 8, wherein the connector is further configured to receive a cable.

10. An electronic device, comprising:
function subassembly;
connector subassembly, wherein the connector subassembly is electrically connected with the functional subassembly to transmit electrical signals, the connector subassembly comprising two connectors that plug into each other, the connector comprising:
a terminal support component, wherein the terminal support component comprises a first surface and a second surface, the first surface is opposite to the second surface or the first surface and the second surface are arranged at intervals;
a multiple of gold fingers symmetrically arranged on the first surface and the second surface; and
an electric conversion component comprising a main electric unit and two auxiliary conductive units, wherein the main electric unit is electrically connected the two auxiliary conductive units and a conductive element; the two auxiliary conductive units are electrically connected with the gold fingers, the multiple of gold fingers are respectively arranged on the first surface and the second surface of the terminal support component.

11. The electronic device of claim 10, wherein a joint connected the two auxiliary conductive units and the main electrical unit is located inside the connector.

12. The electronic device of claim 11, wherein the joint further connects the two auxiliary conductive units with the main electrical unit, and the two auxiliary conductive units are non-contacting and insulated from each other in areas other than the joint.

13. The electronic device of claim 12, wherein the multiple of gold fingers are positioned at a first end of the terminal support component, the gold fingers comprise a first terminal group and a second terminal group arranged at intervals, the first terminal group and the second terminal group has the same number of the gold fingers, the first terminal group is arranged on the first surface, and the second terminal group is arranged on the second surface.

14. The electronic device of claim 13, wherein the electric conversion component is arranged on a second end of the terminal support component opposite to the first end, and the main electrical unit is arranged on a side of the auxiliary conductive unit away from the multiple of gold fingers.

15. The electronic device of claim 14, wherein the terminal support component is plate shaped whose two major surfaces define the first and the second surfaces.

16. The electronic device of claim 15, wherein the connector is further configured to receive a mother board, and the connector further comprises a shell, the shell wraps with the terminal support component, and the first end of the terminal support component is extended toward the opening of the shell.

17. The electronic device of claim 14, wherein the terminal support component is hollow column shaped whose two major surfaces define the first and the second surfaces, the first surface and the second surface are arranged face to face, and the first end of the terminal support component is extended toward the opening of the hollow column terminal support component.

18. The electronic device of claim 17, wherein the connector is further configured to receive a cable.
